(19) United States
(12) Patent Application Publication
(10) Pub. No.: US 2023/0282394 A1
(43) Pub. Date: Sep. 7, 2023

(54) RADIO FREQUENCY (RF) PLENUM CABLE WITH REDUCED INSERTION LOSS

(71) Applicant: John Mezzalingua Associates, LLC, Liverpool, NY (US)

(72) Inventors: Jeremy Charles Benn, Baldwinsville, NY (US); Christopher P. Natoli, Baldwinsville, NY (US); Brandon M. Stevens, Liverpool, NY (US); Shawn Chawgo, PHOENIX, NY (US)

(73) Assignee: John Mezzalingua Associates, LLC, Liverpool, NY (US)

(21) Appl. No.: 18/117,799

(22) Filed: Mar. 6, 2023

Related U.S. Application Data
(60) Provisional application No. 63/317,295, filed on Mar. 7, 2022.

(51) Int. Cl. H01B 11/18; H01B 17/32; H01B 17/36; H01B 3/30

(52) U.S. Cl. CPC H01B 11/1843; H01B 17/32; H01B 17/36; H01B 3/30; H01B 13/016

(57) ABSTRACT

An RF plenum cable has an annular outer conductor and a coaxial inner conductor. Disposed between the inner and outer conductors is a dielectric spine which includes a sleeve that wraps around the inner conductor, and a plurality of circumferentially spaced ribs that project outwardly from an outer surface of the sleeve. Each of the ribs is defined by a tapered configuration having a first thickness at a first end portion coupled to the sleeve, and a second thickness at a second end portion coupled to an inner surface of the outer conductor, in which the first thickness is less than the second thickness. The dielectric spine may be formed of a plastic having a dielectric constant and loss tangent that, combined with the design of the dielectric spine and the dimensions of the inner and outer conductor, allows for a reduced insertion loss at high frequencies (e.g., 6 GHz).

### CROSS REFERENCE TO RELATED APPLICATION

This application claims priority to U.S. Ser. No. 63/317,295, entitled RADIO FREQUENCY (RF) PLENUM CABLE WITH REDUCED INSERTION LOSS, filed Mar. 7, 2022 under relevant portions of 35 U.S.C. § 119 and 37 CFR § 1.51. The entire contents of this application are incorporated herein by reference.

### BACKGROUND

### Technical Field

The present invention relates to wireless communications, and more particularly, to RF (Radio Frequency) cables used to relay RF signals between radio units and their antennas.

### Related Art

The advent of advanced cellular communications, such as LTE (Long Term Evolution) and 5G NR (New Radio), and their demand for increasing bandwidth and data rates, has led to the use of new frequency bands. For example, the introduction of C-Band (3.4-4.2 GHz) places new demands on the radios and RF cables used to carry RF signals between the radios and their antennas. Further, 5G has designated two frequency ranges, FR1 and FR2, in which FR1 covers frequencies up to 6 GHz. The new demands, including the higher frequencies require more stringent requirements, including those relating to insertion loss, among others. Insertion loss refers to the loss of signal power resulting from device insertion in a transmission line or cable, usually expressed in decibels (dB).

### BRIEF DESCRIPTION

Therefore and according to an aspect of the invention there is provided a plenum RF cable. The plenum RF cable includes an inner conductor, an outer conductor, and a dielectric spine that is disposed between the inner conductor and the outer conductor. The dielectric spine has a sleeve that is disposed around and in mechanical contact with the inner conductor as well as a plurality of ribs disposed in spaced relation. Each of the plurality of ribs are mechanically coupled to the exterion of the sleeve, and are further configured to mechanically couple to an inner surface of the outer conductor. Each of the plurality of ribs has a first thickness or width at the portion of the rib that couples to the sleeve, and a second thickness or width at the portion of the rib that couples to the inner surface of the outer conductor. Preferably, the ribs are defined by a tapered configuration in which the first thickness of each rib adjacent the sleeve is less than the second thickness adjacent to the outer conductor of the herein described cable.

According to another aspect of the invention, there is disclosed a method of manufacturing an RF plenum cable with reduced insertion loss, the cable comprising an inner conductor and an outer conductor coaxially disposed about the inner conductor. The method comprises disposing a dielectric spine between the inner conductor and the outer conductor, wherein the dielectric spine includes a sleeve disposed around and in mechanical contact with the inner conductor, and a plurality of ribs mechanically coupled to the outer surface of the sleeve. Each of the plurality of ribs is configured to mechanically couple to the inner surface of the outer conductor and is defined by a tapered configuration including a first thickness at an end portion that couples to the sleeve and a second thickness at an opposing end portion that couples to the inner surface of the outer conductor. The first thickness of each of the ribs is less than the second thickness.

The herein described RF plenum cable design is responsive to the increased demands on increased bandwidth and data rate transmissions for advanced cellular communications and with reduced insertion loss.

These and other features and advantages will be readily apparent from the following Detailed Description, which should be read in conjunction with the accompanying drawings.

### BRIEF DESCRIPTION OF THE DRAWINGS

So that the manner in which the features of the invention can be understood, a Detailed Description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views.

FIG. 1 illustrates a section of an exemplary RF cable in accordance with an exemplary embodiment; and

FIG. 2 illustrates a cross section of an exemplary dielectric spine for use in an RF cable in accordance with aspects of the invention.

### DETAILED DESCRIPTION

The following Detailed Description should be read with reference to the drawings, in which like elements in different drawings are identically numbered. The drawings, which are not necessarily to scale, depict selected embodiments and are not intended to limit the scope of the invention. The Detailed Description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

The following describes an exemplary embodiment of an RF plenum cable in accordance with aspects of the invention. Throughout the discussion which follows, a number of terms are used in order to provide a suitable frame of reference in regard to the accompanying drawings. These terms, which may include “distal”, “proximal”, “inner”, “outer” and the like are not intended to overly narrow scope, except where so specifically indicated. In addition, the herein described cable embodiment is described with various dimensions for aiding in description purposes. It will be readily understood that the dimensions of the various aspects and features can be suitably varied. In addition, the accompanying drawings are provided to show salient features of the inventive RF plenum cable and should not be used for scaling purposes.

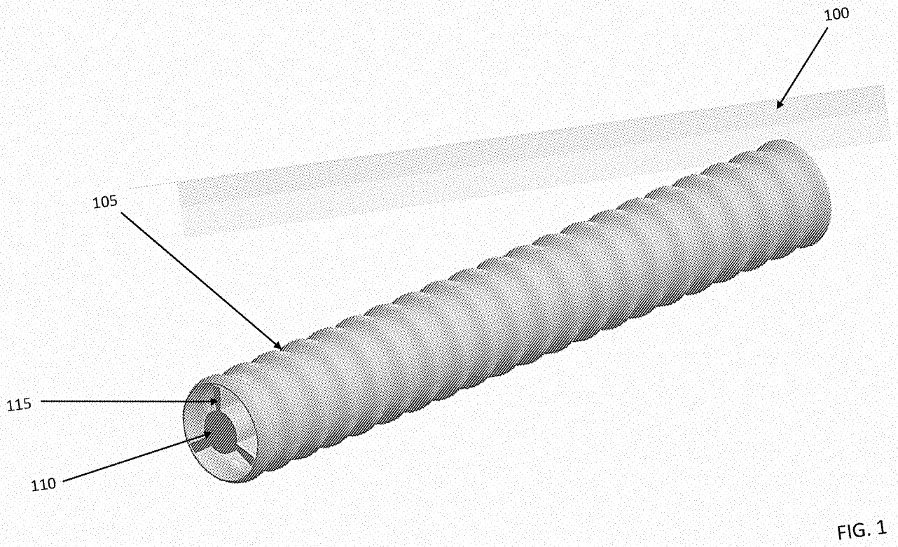

With reference to the drawings, FIG. 1 illustrates a linear section or portion of an RF plenum cable 100. The RF plenum cable 100 according to this particular embodiment may be al/2 inch cable used to relay RF signals between radios and antennas in an LTE or 5G RAN (Radio Access Network) deployment. As shown, the RF plenum cable 100 has an outer conductor 105, which may be an annular outer conductor; an inner conductor 110, which is coaxial with the outer conductor 105, and a dielectric spine 115, the latter of which surrounds the inner conductor 110. The dielectric spine 115 provides support between the inner conductor 110 and outer conductor 105, as well as electrical isolation, in addition to providing mechanical support for resiliency and flexibility of the herein described RF plenum cable 100. Being a plenum cable, the inner volume of the RF plenum cable 100 contains air as a dielectric, in addition to the dielectric spine 115, which extends over the length or span of the RF plenum cable 100.

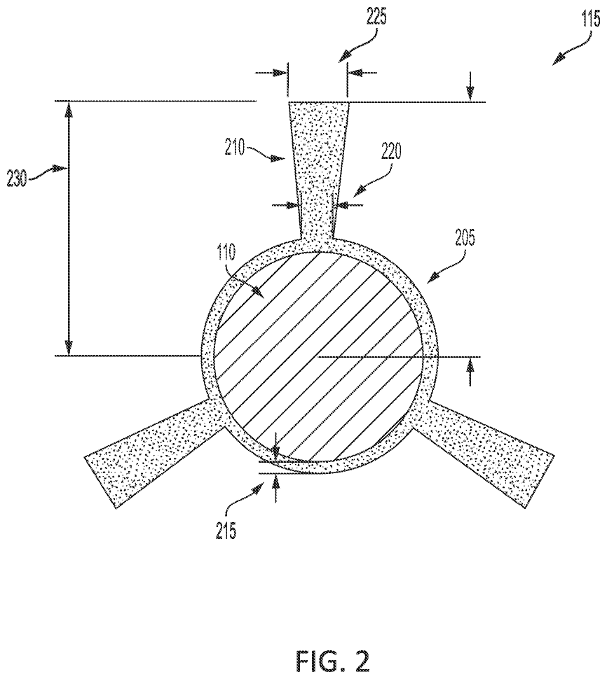

FIG. 2 illustrates a cross section of the RF plenum cable, such as the cable shown in FIG. 1 and more specifically depicting an exemplary dielectric spine 115. The dielectric spine 115 includes a sleeve 205, which cylindrically surrounds the inner conductor 110 of the cable 100, and further includes a plurality of ribs 210 that extend or project radially outward from an outer surface 215 of the sleeve 205. According to this exemplary embodiment, three (3) ribs 210 are circumferentially and equally spaced at 120 degree intervals from one another. Each outwardly projecting rib 210 is defined by a tapered geometry. More specifically and according to this exemplary embodiment, each rib 210 includes an inner width or thickness 220 corresponding to the width of the rib 210 at a first end portion of the rib 210 that meets the outer surface of the sleeve 205. Each rib 210 further includes an outer width or thickness 225 corresponding to the width of the rib 210 at a opposing second end portion of the rib 210 that mechanically engages with an inner surface of the outer conductor 205 of the RF plenum cable 100.

The sleeve 205 of the dielectric spine 115 has an inner diameter that causes the sleeve 205 to make consistent mechanical contact with an outer surface of the inner conductor 110, which may have a diameter of 0.195″ according to this exemplary embodiment. For purposes of this present embodiment, the sleeve 205 may have an overall thickness 215 of 0.012″, with the inner width or thickness 220 of each rib 210 being 0.029″ and the outer width or thickness 225 of each rib 210 being 0.055″. A length dimension of each rib 210 may be such that the distance from the center of the inner conductor 110 and the end of a given rib 210 where the rib 210 meets or contacts the inner surface of the outer conductor 105 (designated by reference number 230 in FIG. 2) may be 0.235″. According to this exemplary embodiment, the dielectric spine 115 may be formed substantially of a plastic material, such as Dow Axeleron, which has a dielectric constant of 2.27 and a loss tangent of 7e⁻⁵. It will be understood that other suitable materials may be used, provided that these alternative materials possess similar dielectric and loss tangent properties. However, it will be further understood that use of an alternative material having different dielectric and loss tangent properties may require an adjustment(s) in the dimensions of the dielectric spine 115. It will be understood that such variations are possible and within the scope of the herein described invention.

The cross sectional shape of the dielectric spine 115, including the tapered shape of each projecting rib 210, provides for improved insertion loss while maintaining mechanical resilience of the RF plenum cable 100. This is the result of several factors. For example, the geometry of each tapered rib 210, which includes the narrower inner width 220 and the wider outer width 225, provides for a minimal use of material for each rib 210 while at the same time providing maximum support by increasing the surface area at the end portion of the rib 210 that engages the inner surface of the outer conductor 105. The design of the cross sectional shape of dielectric spine 115 is such that it utilizes a minimal amount of plastic, because under operation, RF energy conducted through the RF plenum cable 100 heats up the plastic of any dielectric disposed between the inner conductor 110 and the outer conductor 105. The subsequent dissipation of the built-up head is a primary driver of insertion loss. Accordingly, removing as much plastic as possible improves the insertion loss of the cable 100. Another factor in reducing the insertion loss of the RF plenum cable 100 is increasing the diameter of the inner conductor 110. As disclosed above with the exemplary embodiment, the diameter of the inner conductor 110 according to this specific embodiment is 0.195″. This latter dimension is slightly larger than the industry standard inner conductor diameter of 0.189″. The outer conductor 105 may have an annular shape with a minimum diameter of 0.481″.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof “At least one of element A, element B, and element C” is not intended to be limited to at least one of an element A, at least one of an element B, and at least one of an element C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims.

1. A plenum RF (Radio Frequency) cable, comprising:
an inner conductor having an inner surface and an outer surface;
an outer conductor having an inner surface and an outer surface coaxially disposed in relation to the inner conductor; and
a dielectric spine disposed between the inner conductor and the outer conductor, the dielectric spine comprising:
a sleeve disposed around and in mechanical contact with the inner conductor, and
a plurality of ribs mechanically coupled to the outer surface of the sleeve, wherein each of the plurality of ribs is configured to mechanically couple to the inner surface of the outer conductor, each of the plurality of ribs having a tapered configuration including a first thickness at an end portion that couples to the sleeve, and a second thickness at an opposing end portion that couples to the inner surface of the outer conductor, wherein the first thickness is less than the second thickness.

2. The plenum RF cable of claim 1, wherein the plurality of ribs comprises three (3) ribs.

3. The plenum RF cable of claim 1, wherein each of the plurality of ribs are equally spaced in relation to one another.

4. The plenum RF cable of claim 1, wherein the dielectric spine comprises a plastic.

5. The plenum RF cable of claim 4, wherein the plastic comprises:
a dielectric constant of 2.27; and
a loss tangent of 7e⁻⁵.

6. The plenum RF cable of claim 1, wherein the sleeve comprises a thickness of 0.012″.

7. The plenum RF cable of claim 1, wherein the first thickness of each rib is 0.029″, and wherein the second thickness of each rib is 0.055″.

8. The plenum RF cable of claim 1, wherein the inner conductor comprises a diameter of 0.195″.

9. The plenum RF cable of claim 8, wherein the outer conductor comprises a minimum diameter of 0.481″.

10. The plenum RF cable of claim 1, wherein the outer conductor comprises an annular shape.

11. The plenum RF cable of claim 1, wherein cable further includes air as a dielectric.

12. A method of manufacturing an RF plenum cable with reduced insertion loss, the cable comprising an inner conductor and an outer conductor coaxially disposed about the inner conductor, the method comprising;
disposing a dielectric spine between the inner conductor and the outer conductor, the dielectric spine comprising:
a sleeve disposed around and in mechanical contact with the inner conductor, and
a plurality of ribs mechanically coupled to the outer surface of the sleeve, wherein each of the plurality of ribs is configured to mechanically couple to the inner surface of the outer conductor, each of the plurality of ribs having a tapered configuration including a first thickness at an end portion that couples to the sleeve, and a second thickness at an opposing end portion that couples to the inner surface of the outer conductor, wherein the first thickness is less than the second thickness.

13. The method of claim 12, wherein the dielectric spine includes three ribs, each rib being circumferentially and equally spaced in relation to one another about the sleeve.
